(19) United States
(12) Patent Application Publication
(10) Pub. No.: US 2026/0205764 A1
(43) Pub. Date: Jul. 16, 2026

(54) MAP-BASED USER INTERFACE WITH ENHANCED DISPLAY OF GEOGRAPHIC LOCATIONS OF DESTINATIONS

(71) Applicant: Optum Services (Ireland) Limited, Dublin (IE)

(72) Inventors: Kurt Darmanin, Dublin (IE); Ciarán McKenna, Dublin (IE); Kieran Luke Casey, Dublin (IE)

(21) Appl. No.: 19/016,801

(22) Filed: Jan. 10, 2025

(51) Int. Cl. H04W 4/021

(52) U.S. Cl. CPC H04W 4/021

(57) ABSTRACT

A computer-implemented method comprises obtaining an initial data set comprising a plurality of combinations; determining a filtered data set from the initial plurality of combinations; determining ratings of the destinations based on the filtered data set; and receiving a map request, and in response to receiving the map request, causing a display device to display a map comprising indicators that indicate geographic locations of a subset of the destinations and information based on the Elo ratings of destinations in the subset of the destinations.

### TECHNICAL FIELD

This disclosure relates to computing systems for map-based user interfaces.

### BACKGROUND

Users rely on map-based user interfaces for a wide variety of purposes. For example, a user's computing device may display a graphical user interface (GUI) that contains a map of an area. The map may also include indicators that indicate the geographic locations of specific types of destinations, such as grocery stores, pharmacies, clinics, restaurants, and so on. Seeing such indicators on a map may help the users know where the destinations are geographically located relative to the users' current locations.

### SUMMARY

The present disclosure describes techniques for providing improved map-based graphical user interfaces (GUIs). As described herein, a map-based GUI may include a map having indicators indicating geographic locations of destinations. The indicators are associated with ratings based on behavior of users of the destinations, as opposed to subjective reviews submitted by the users of the destinations. That is the ratings of the filtered destinations may be based on relative utilization of the destinations by users. As described herein, the ratings may be Elo ratings. Such a map-based GUI may present information that users need more efficiently than previous map-based GUIs.

In one example, this disclosure describes a computer-implemented method comprising: obtaining, by one or more processors, an initial data set comprising a plurality of combinations of users in a plurality of users and destinations in a plurality of destinations; determining, by the one or more processors, a filtered data set from the initial data set, wherein the filtered data set does not include any combination in the initial data set in which: a distance from a geographic location of a destination of the combination to a geographic location of a user of the combination is greater than a threshold distance, the distance from the geographic location of the destination to the geographic location of the user is greater than a distance from the geographic location of the user to a geographic location of a most-utilized destination for the user among the plurality of destinations, and the geographic location of the destination is closer to the geographic location of the user than a geographic location of any other destination in the plurality of destinations; determining, by the one or more processors, ratings of filtered destinations, the filtered destinations being destinations specified by the combinations in the filtered data set, wherein the ratings of the filtered destinations are based on relative utilization of the filtered destinations by filtered users, the filtered users being users specified by the combinations in the filtered data set; and receiving, by the one or more processors, a map request; and in response to the map request, causing, by the one or more processors, a display device to display a map comprising indicators that indicate geographic locations of a subset of the destinations and information based on the ratings of destinations in the subset of the destinations.

In another example, this disclosure describes a system comprising: one or more processors; and one or more memories storing processor-executable instructions that, when executed by the one or more processors, cause the one or more processors to perform operations comprising: obtaining an initial data set comprising a plurality of combinations of users in a plurality of users and destinations in a plurality of destinations; determining a filtered data set from the initial data set, wherein the filtered data set does not include any combination in the initial data set in which: a distance from a geographic location of a destination of the combination to a geographic location of a user of the combination is greater than a threshold distance, the distance from the geographic location of the destination to the geographic location of the user is greater than a distance from the geographic location of the user to a geographic location of a most-utilized destination for the user among the plurality of destinations, and the geographic location of the destination is closer to the geographic location of the user than a geographic location of any other destination in the plurality of destinations; determining ratings of filtered destinations, the filtered destinations being destinations specified by the combinations in the filtered data set, wherein the ratings of the filtered destinations are based on relative utilization of the filtered destinations by filtered users, the filtered users specified by the combinations in the filtered data set; receiving a map request; and in response to the map request, causing a display device to display a map comprising indicators that indicate geographic locations of a subset of the destinations and information based on the ratings of destinations in the subset of the destinations.

In another example, this disclosure describes one or more non-transitory computer-readable media storing processor-executable instructions that, when executed by one or more processors, cause the one or more processors to perform operations comprising: obtaining an initial data set comprising a plurality of combinations of users in a plurality of users and destinations in a plurality of destinations; determining a filtered data set from the initial data set, wherein the filtered data set does not include any combination in the initial data set in which: a distance from a geographic location of a destination of the combination to a geographic location of a user of the combination is greater than a threshold distance, the distance from the geographic location of the destination to the geographic location of the user is greater than a distance from the geographic location of the user to a geographic location of a most-utilized destination for the user among the plurality of destinations, and the geographic location of the destination is closer to the geographic location of the user than a geographic location of any other destination in the plurality of destinations; determining ratings of filtered destinations, the filtered destinations being destinations specified by the combinations in the filtered data set, wherein the ratings of the filtered destinations are based on relative utilization of the filtered destinations by filtered users, the filtered users being specified by the combinations in the filtered data set; receiving a map request for a mapping application; and in response to the map request, causing a display device to display a map comprising indicators that indicate geographic locations of a subset of the destinations and information based on the ratings of destinations in the subset of the destinations.

The details of one or more aspects of the disclosure are set forth in the accompanying drawings and the description below. Other features, objects, and advantages of the techniques described in this disclosure will be apparent from the description, drawings, and claims.

### BRIEF DESCRIPTION OF THE DRAWINGS

FIG. 1 is a block diagram illustrating an example system in accordance with one or more aspects of this disclosure.

FIG. 2 is a flowchart illustrating an example operation of a rating system, in accordance with one or more techniques of this disclosure.

FIG. 3 is a flowchart illustrating an example operation for determining Elo ratings of destinations, in accordance with one or more techniques of this disclosure.

FIGS. 4A-4D are conceptual diagrams illustrating an example process for determining a filtered data set.

FIG. 5 illustrates an example graphical user interface (GUI) in accordance with one or more techniques of this disclosure.

### DETAILED DESCRIPTION

The present disclosure describes techniques for providing improved map-based graphical user interfaces (GUIs). As described herein, a computing device may output a map-based GUI for display. The map-based GUI may include a map of a geographic area and include indicators that indicate geographic locations of specific types of destinations. For example, the map may include a fork and knife icon to indicate a geographic location of a restaurant, a shopping cart icon to indicate a geographic location of a supermarket, an RX icon to indicate a geographic location of a pharmacy, and so on.

One problem with current map-based GUIs is that it may be difficult for a user to determine which of several available destinations would be best-suited for the user. Conventional user interfaces may display star-based ratings associated with the indicators, or display user-derived comments. However, users are aware that such ratings and comments are subjective and often manipulated. Thus, the user of a map-based GUI may be able to review ratings and comments of destinations and the relative geographic locations of the destinations, the map-based GUI does not provide the user with any objective indication of whether a destination is better, especially not with real-time updates.

This disclosure describes techniques that may address these issues. As described herein, a computing system obtains an initial data set comprising a plurality of combinations. The combinations are different combinations of users in a plurality of users and destinations in a plurality of destinations. Additionally, the computing system may determine a filtered data set from the initial plurality of combinations. The filtered data set does not include any combination in the initial data set in which one or more of the following apply: a distance from a geographic location of a destination of the combination to a geographic location of a user of the combination is greater than a threshold distance, the distance from the geographic location of the destination to the geographic location of the user is greater than a distance from the geographic location of the user to a geographic location of a most-utilized destination for the user among the plurality of destinations, or the geographic location of the destination is closer to the geographic location of the user than a geographic location of any other destination in the plurality of destinations.

The computing system may determine ratings of filtered destinations. The filtered destinations are destinations specified by the combinations in the filtered data set. The ratings of the filtered destinations may be based on relative utilization of the filtered destinations by filtered users. The filtered users are specified by the combinations in the filtered data set.

The ratings of the destinations are objective because the ratings are based on aggregate behavior of the users. Moreover, because the filtered data set excludes any combination in the initial data set in which a geographic location of a destination of the combination is closer to a geographic location of a user of the combination than a geographic location of any other destination in the plurality of destinations, the filtered data set represents destinations for which the users physically went out of their way to utilize. A user going further than a closest destination to reach another destination is a strong indicator that the user prefers to the other destination. Thus, the computing system may generate indicators on a map based on the ratings. For example, the computing system may filter the indicators so that only indicators of higher-rated destinations are shown. Moreover, since the combinations and most-utilized destinations for users may be determined on an ongoing basis, which indicators are shown on the map may be based on current user behavior. In this way, the techniques of this disclosure may improve map-based GUIs.

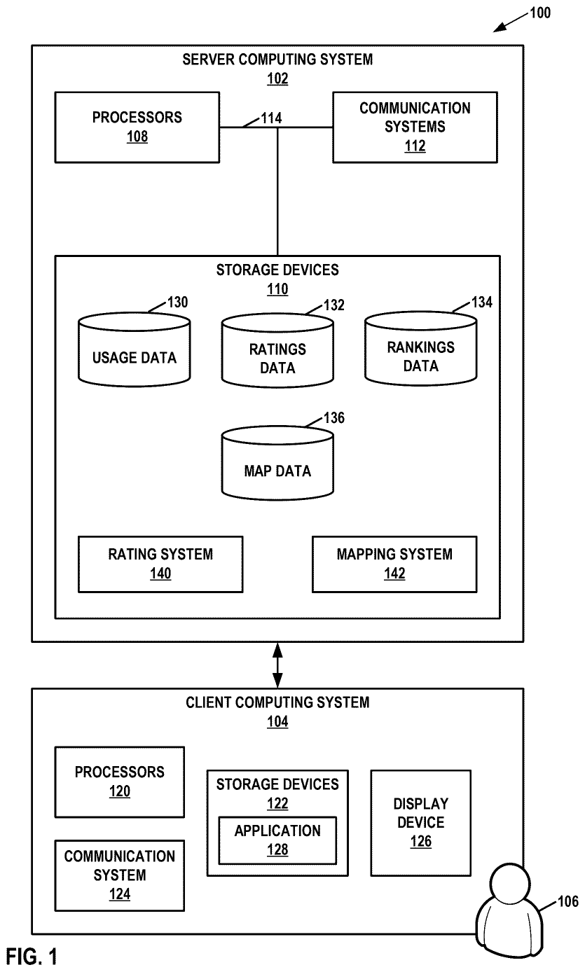

FIG. 1 is a block diagram illustrating an example system 100 in accordance with one or more aspects of this disclosure. In the example of FIG. 1, system 100 includes server computing system 102 and a client computing system 104. Server computing system 102 and client computing system 104 may communicate with one another via one or more communication channels, such as a communication networks (e.g., the Internet). Server computing system 102 and client computing system 104 may each include one or more computing devices. Example types of computing devices include server devices, personal computers, mobile devices (e.g., smartphones, tablet computers, wearable devices), intermediate network devices, and so on. Server computing system 102 may be a cloud-based computing system. A map user 106 may use client computing system 104. In other examples, system 100 may include more, fewer, or different components.

As shown in the example of FIG. 1, server computing system 102 includes one or more processors 108, one or more storage devices 110, one or more communication systems 112, and one or more communication channels 114. Processors 108 are electronic circuits configured to provide processing functionality. For example, processors 108 may execute processor-executable instructions that cause processors 108 to provide specific processing functionality. Example types of processors may include microprocessors, application-specific integrated circuits, and so on. Storage devices 110 are devices capable of storing information, such as data and processor-executable instructions. Example types of storage devices may include solid state memory units, random access memory units, hard disk drives, and other types of devices for storage data. Example storage devices may include volatile memory devices that do not retain data when powered-off and non-volatile memory devices that do retain data when powered-off. Communication systems 112 are capable of sending and receiving data to and from computing devices. Example types of communication systems may include network interface cards, wireless communication systems, and so on. Communication channels 114 may facilitate communication among processors 108, storage devices 110, communication system 112, and other systems of server computing system 102. Example types of communication channels may include buses, network communication channels, communication networks, and so on. Communication channels 114 may connect components within computing devices and/or connect different computing devices. Each of processors 108, storage devices 110, communication systems 112, and communication channels 114 may be within a single computing device or one or more of processors 108, storage devices 110, communication systems 112, and communication channels 114 may be distributed among multiple computing devices.

Client computing system 104 may include processors 120, storage devices 122, communication system 124, and a display device 126. Processors 120, storage devices 122, and communication system 124 may be implemented in a manner similar to the corresponding components described above with respect to server computing system 102. Display device 126 is a device or component configured to display GUIs and other imagery. Example types of display device 126 may include liquid crystal display (LCD) displays, light emitting diode (LED) displays, and so on.

In the example of FIG. 1, storage devices 122 include processor-executable instructions associated with an application 128. Processors 120 of client computing system 104 may execute the processor-executable instructions associated with application 128. For ease of explanation, this disclosure describes application 128 as performing actions when processors 120 execute processor-executable instructions associated with application 128. Application 128 is an application configurable to present a map-based GUI on display device 126. In some examples, application 128 comprises a web browser application. In some examples, application 128 comprises a special-purpose application.

In the example of FIG. 1, storage devices 110 of server computing system 102 may store usage data 130, ratings data 132, rankings data 134, and maps data 136. Additionally, storage devices 110 may store processor-executable instructions associated with a rating system 140 and a mapping system 142. Processors 108 may execute the processor-executable instructions associated with rating system 140 and mapping system 142. Execution of the processor-executable instructions associated with rating system 140 and mapping system 142 by processors 108 causes processors 108 to perform operations associated with rating system 140 and mapping system 142. For ease of explanation, this disclosure may describe operations performed by processors 108 when executing processor-executable instructions associated with rating system 140 and mapping system 142 as being performed by rating system 140 and mapping system 142.

Usage data 130 may include records of users utilizing destinations. Example types of users may include customers, clients, patients, or other types of people who use destinations. Example types of destinations may include various types of businesses (e.g., pharmacies, grocery stores, restaurants, etc.), various types of medical facilities (e.g., dentist offices, vision care centers, dialysis centers, doctors' offices, etc.), government services locations (e.g., motor vehicle registration centers, libraries, etc.), and other types of places or things having defined geographic locations.

Server computing system 102 may obtain usage data 130 in various ways, including from the destinations. For example, the destinations may include pharmacies. In this example, a pharmacy benefits manager may receive pharmacy benefit reimbursement requests from the pharmacies. Usage data 130 may include or may be generated (e.g., by server computing system 102) based on the pharmacy benefit reimbursement requests. In some examples, businesses may use rewards benefit programs to incentivize customers to utilize their destinations. When a user makes a purchase from the business, the business may generate a record to associate the purchase with the user. Usage data 130 may include or may be generated (e.g., by server computing system 102) based on such records.

In general terms, rating system 140 is configured to generate ratings for destinations. As described in greater detail below, rating system 140 may use usage data 130 to generate ratings data 132. Ratings data 132 may include data indicating ratings for the destinations. In some examples, rating system 140 may use ratings data 132 to generate rankings data 134. Rankings data 134 may include data indicating a ranking of destinations.

Mapping system 142 may use map data 136 and one or more of ratings data 132 or rankings data 134 to generate GUI data. The GUI data may include data for outputting a map-based GUI that contains a map that includes indicators of geographic locations of destinations. In some examples, mapping system 142 filters destinations based on one or more of ratings data 132 or rankings data 134 so that the GUI data includes indicators of geographic locations of some destinations and no others. In some examples, the indicators may include or otherwise be associated with information based on one or more of ratings data 132 or rankings data 134. For instance, the indicators may be color-coded based on one or more of ratings data 132 or rankings data 134. In some instances, the GUI may display pop-up elements that contain information based on one or more of ratings data 132 or rankings data 134 when input (e.g., tapping, clicking, mouse pointer hover, etc.) is detected with respect to the indicators.

In some examples, mapping system 142 may receive a map request from application 128 for GUI data. For example, application 128 may send, and mapping system 142 may receive, a hypertext transfer protocol (HTTP) request for the GUI data. In other examples, application 128 may send map requests using other protocols. In some examples, mapping system 142 may implement an application programming interface (API) for receiving map requests from application 128. Thus, in some examples, server computing system 102 may receive a map request from client computing system 104 for GUI data. To cause display device 126 to display the map, server computing system 102 may send the GUI data to client computing system 104 in response to the map request. In some examples, server computing system 102 may generate a ranking and/or determine a subset of the destinations in response to the map request.

In some examples, application 128 may also send information indicating a geographic location associated with map user 106. For instance, application 128 may receive an indication of user input from map user 106 to specify the geographic location associated with map user 106. In some examples, application 128 may be configured to automatically send a geographic location associated with map user 106 derived using on a satellite navigation system. In some examples, application 128 may be configured to automatically send a geographic location associated with map user 106 derived using an Internet Protocol (IP) address of client computing system 104. In some examples, mapping system 142 may determine a geographic location associated with map user 106 based on the IP address of client computing system 104.

In response to the map request from application 128, mapping system 142 may generate the GUI data and send the GUI data to application 128. Application 128 may interpret the GUI data to generate data displayable by display device 126. In some examples, mapping system 142 may generate the GUI data based in part on the geographic location associated with map user 106. For example, mapping system 142 may retrieve map tiles of map data 136 based on the geographic location associated with map user 106. Each of the map tiles may be an image of a portion of a map that is associated with a specific geographic area. Additionally, mapping system 142 may identify a subset of the destinations based on one or more criteria. The criteria may include one or more geographic criteria. The geographic criteria may include proximity of the geographic locations of the destinations and the geographic location associated with map user 106. For example, mapping system 142 may identify destinations within a specified radius of the geographic location associated with map user 106. In some examples, the geographic criteria may include an estimated travel time. For instance, mapping system 142 may identify destinations within a specified estimated travel time of the geographic location associated with map user 106. In some examples, application 128 may send, and mapping system 142 may receive, requests to update the specified radius and/or specified estimated travel time. For instance, a map-based GUI displayed by display device 126 of client computing system 104 may include a GUI element, such as an input box or a slider element that enables map user 106 to select the radius and/or estimated travel time. Other criteria may include a minimum rating, a minimum ranking, a minimum subjective rating, whether the destinations are currently open, whether the destinations participate in a pharmacy benefit management network, whether the destinations participate in a health insurance network, or other criteria. Rating system 140 or mapping system 142 may generate a ranking of destinations in the subset of the destinations based on the ratings of the destinations. In an example where one of the criteria is based on a ranking of the destinations, mapping system 142 may determine, in response to receiving the map request from application 128, a ranking of the destinations based on the ratings of destinations that satisfy one or more other criteria. A map-based user interface presented by client computing system 104 may include elements (e.g., text boxes, radio buttons, drop-down boxes, etc.) for selecting one or more of the criteria.

Mapping system 142 may generate indicator data that specify indicators that indicate the geographic locations of destinations that satisfy the geographic criteria. The GUI data may include the indicator data. The indicator data may include information based on the ratings and/or rankings of the identified destinations. For example, the information may include color-coded data corresponding to the ratings and/or rankings of the identified destinations.

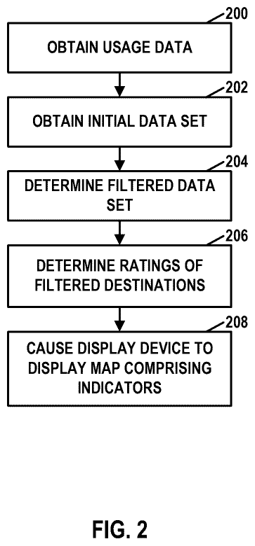

FIG. 2 is a flowchart illustrating an example operation of rating system 140, in accordance with one or more techniques of this disclosure. In the example of FIG. 2, rating system 140 may obtain usage data 130 (200). Usage data 130 may include records of users utilizing destinations. For instance, in an example where the users are patients and the destinations are pharmacies, usage data 130 may include records of the patients utilizing the pharmacies to receive medications, pharmaceuticals, or other healthcare products. In this example, usage data 130 may include or may be derived from pharmacy benefit reimbursement requests. A pharmacy may submit pharmacy benefit reimbursement requests to a pharmacy benefit management organization. The pharmacy benefit reimbursement requests may identify the patient, the patient's home address, the geographic location of the pharmacy, types and quantities of healthcare products provided, the costs for such healthcare products, and other types of information. In some examples, information from two or more different sources may be combined (e.g., by rating system 140) to obtain usage data 130. For instance, information from a pharmacy benefit reimbursement request may be combined with information from a patient database (e.g., home address information) to obtain usage data 130. In some examples, usage data 130 may include geocoded addresses of destinations and users. In this way, in some examples, server computing system 102 may obtain reimbursement requests from the destination and generate initial data set based on the reimbursement requests.

The usage data may be limited to a specific time period, such as a specific month, year, quarter, a length of time leading up to a current time, and so on. Rating system 140 may obtain the usage data on a rolling basis. For instance, rating system 140 may receive new usage data according to a refresh cycle (e.g., a hourly, daily, weekly, or monthly basis) and may determine ratings for destinations based on usage data obtained over a period longer than the refresh cycle.

Additionally, rating system 140 may obtain an initial data set (202). The initial data set comprises a plurality of combinations. The combinations are different combinations of users in a plurality of users and destinations in a plurality of destinations. The combinations may include combinations of each user with each destination regardless of whether the user utilized the destination. Rating system 140 may determine the users and the destinations based on usage data 130. Thus, in some examples, the users may be all users indicated in usage data 130 and the destinations may be all destinations indicated in usage data 130.

Rating system 140 may determine a filtered data set from the initial data set (204). Rating system 140 may filter the combinations from the initial data set to determine the filtered data set based on one or more conditions. For example, the initial data set may be filtered so that the filtered data set does not include any combination in the initial data set in which a distance from a geographic location of a destination of the combination to a geographic location of a user of the combination is greater than a threshold distance.

In some examples, the initial data set may be filtered so that the filtered data set does not include any combination in the initial data set in which the distance from the geographic location of the destination to the geographic location of the user is greater than a distance from the geographic location of the user to a geographic location of the most-utilized destination for the user among the plurality of destinations. Thus, in some examples, for each respective user of the plurality of users, among destinations specified by combinations in the initial data set that specify the respective user, the most-utilized destination for the respective user is a destination most utilized by the respective user. For example, for a given patient, the most-utilized destination may be the pharmacy that the given patient uses most. Rating system 240 may determine the most-utilized destinations for the users based on usage data 130. Since usage data 130 may change over time and between different time periods, a user's most-utilized destination may change over time, which has an effect on the ratings ultimately determined for the destinations.

In some examples, the initial data set may be filtered so that the filtered data set does not include any combination in the initial data set in which the geographic location of the destination is closer to the geographic location of the user than a geographic location of any other destination in the plurality of destinations. The filtered data set may exclude a combination specifying a user's closest destination, regardless of whether the user's closest destination is the user's most-utilized destination.

Thus, in some examples, the initial data set may exclude combinations where the destination's location is over a threshold distance from the user's location, where the destination's location is further from the user's location than the user's most-utilized destination, and/or where the destination is closest to the user. Excluding some or all such combinations may result in the filtered data set not applying to instances where a user utilized a destination merely because the destination was the closest of the destinations to the user. Users frequently utilize their closest destination regardless of quality due to simple convenience. However, users that utilize destinations that are further from their geographic locations are likely to forgo the convenience of their closest destination because the experience of utilizing the further destination is preferrable to the experience of utilizing the closest destination. Thus, the filtered data set is more likely to capture instances where users go out of their way to utilize destinations. Intuitively speaking, the further a user is willing to travel (and therefore the amount of convenience foregone) may be directly related to the quality that the user perceives the destination as providing, while at the same time more distant destinations than the user's most-utilized destination are likely used for convenience instead of perceived quality.

As noted above, in some examples, the filtered data set does not include any combination in the initial data set in which a distance from a geographic location of a destination of the combination is greater than a threshold distance from a geographic location of a user of the combination. For example, rating system 140 may filter out any combination which does not satisfy the following longitude requirement:

$$\vert {long}_{estb} - {long}_{{mem}_{}} \vert < \frac{r}{{p}_{estb}}$$

In the equation above and elsewhere in this disclosure, the following definitions may apply:
long_{estb}: Longitude of the destination's geographic location,
longₚₐₜ indicates a longitude of the user's geographic location,
p_{long} is a parameter for the minimum threshold for the difference in longitude coordinates. In some examples, a value of 72.380 kilometers (km) may be used for p_{long}.
r indicates a radius threshold for the maximum distance between destinations and users. In some examples, a value of 100 km may be used for r.

The user's geographic location may be the geographic location of user's home or another geographic location associated with the user, such as an office or workplace.

Rating system 140 may filter out any combination which does not satisfy the following latitude requirement:

$$\vert {lat}_{estb} - {lat}_{pat} \vert < \frac{r}{{p}_{l a t}} .$$

In the equation above and elsewhere in this disclosure, the following definitions may apply:
lat_{estb}: Latitude of the destination's geographic location.
latₚₐₜ: Latitude of the user's geographic location.
pₗₐₜ: A parameter for the minimum threshold for the difference in latitude coordinates. In some examples, a value of 111.195 km may may be used for pₗₐₜ.

Then, by making use of the Haversine formula, rating system 140 may calculate the distance between the user's geographic location and the destination's geographic location, D_{estb,pat}, and filter out any combinations that do not satisfy the requirement D_{estb,pat}<r, such that:

$$A = {sin}^{2} ( \frac{\vert {lat}_{estb} - {lat}_{pat} \vert}{2} ) + cos ( {lat}_{estb} ) cos ( {lat}_{pat} ) {sin}^{2} ( \frac{\vert {long}_{estb} - {long}_{pat} \vert}{2} )$$

$$C = 2 a tan 2 ( \sqrt{A} , \sqrt{1 - A} )$$

$${D}_{estb , pat} = BC$$

In the equations above and elsewhere in this disclosure, the following definitions may apply:
B: Approximate radius of the Earth. In some examples, a value of 6378.1370 km may be used.
D_{estb,pat}: Geographical distance between a destination and a user, as per the Haversine formula.

Given that the computations needed to obtain D_{estb,pat} can be computationally expensive, filtering out combinations that do not satisfy the longitude and latitude requirements may efficiently filter out combinations that are outside of the radius threshold, r. If the geographic locations of the user and destination are in the northern hemisphere, the value for the parameter p_{long} may depend on the maximum latitude value of the coordinates available, whereas if the geographic locations of the user and destination are in the southern hemisphere, the value for the parameter p_{long} may depend on the minimum latitude value. In some examples, the value for the parameter pₗₐₜ can always be 111.195 km, given that the unit difference in latitude is constant, irrespective of the location on Earth.

Since users may utilize relatively distant destination on occasion, such as while traveling, it is unlikely that the users' decisions to utilize such relatively distant destinations are related to the users' perceptions of quality provided by the destinations. Thus, filtering out combinations where distances from geographic locations of the destinations of the combinations are greater than a threshold distance from geographic locations of users of the combinations may prevent combinations having relatively distant destinations from distorting the ratings for the destinations. For instance, a destination located near a major highway may be utilized by many long-distance travelers who utilize the destination because the destination is along their way, as opposed to any actual preference for the destination. Filtering combinations in this way may prevent such combinations from distorting ratings of the destinations.

In some examples, rating system 140 determines, for each user of the plurality of users, initial ranks of combinations in the initial data set that specify the user. In some such examples, the filtered data set does not include any combination in the initial data set in which an initial rank of a combination specifying the user is greater than an initial rank of a combination specifying the user and the most-utilized destination for the user. For example, rating system 140 may, for each user, rank the distances of the destinations from the user in ascending order. Rating system 140 may then remove any combinations specifying the user where the destination is further away from that user's geographic location than the user's most-utilized destination in the time period. In some examples, rating system 140 may remove any combinations involving users whose most-utilized destinations' distance rank is greater than rankₘₐₓ, where rankₘₐₓ indicates maximum allowable user-to-destination distance rank for the user's most-used destination. Rating system 140 may then remove any combination where the user's most-used destination in the time period is the closest destination to the user.

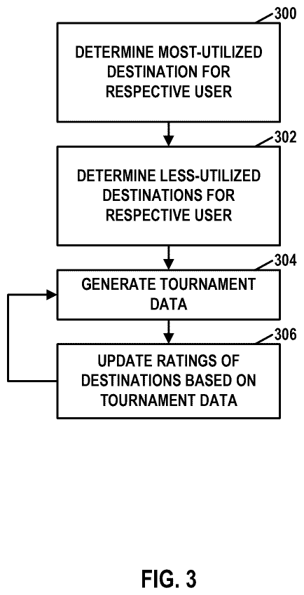

Furthermore, rating system 140 may determine ratings (e.g., Elo ratings) of filtered destinations (208). The filtered destinations are destinations specified by the combinations in the filtered data set. The ratings of the filtered destinations may be based on relative utilization of the filtered destinations by filtered users. The filtered users are users specified by the combinations in the filtered data set. In some examples, the ratings may be Elo ratings. An example operation to determine the Elo ratings of the destinations is described below with respect to FIG. 3. In other examples, the ratings may be other types of ratings.

In some examples, rating system 140 ranks the filtered destinations based on the ratings of the filtered destinations. In some examples, rating system 140 limits the ranking of the filtered destination to destinations that are within a specific local area. In some examples, rating system 140 ranks the filtered destinations in response to a map request from map user 106 of client computing system 104. In this example, rating system 140 may determine a geographic location of map user 106, determine destinations having geographic locations within a location area of the geographic location of map user 106 and rank the determined destinations. Map user 106 may or may not be one of the users.

Mapping system 142 may cause a display device (e.g., display device 126 or another display device) to display a map comprising indicators that indicate geographic locations of a subset of the destinations and information based on the ratings of destinations in the subset of the destinations (210). In some examples, mapping system 142 may receive a map request and, in response to the map request, cause the display device to display the map. In some examples, mapping system 142 determines, based on data sent by client computing system 104, a geographic location associated with map user 106 of client computing system 104 and determines the subset of the destinations based on the geographic location associated with map user 106.

For example, map data 136 may include data describing maps of one or more geographic regions. The maps may include road networks, political boundaries, physical features, and so on. Mapping system 142 may use map data 136 and data generated by rating system 140 (e.g., ratings data 132 or rankings data 134) to generate map-based GUI data. The map-based GUI data may include data usable for presenting a map-based GUI. For example, the map-based GUI data may include Hypertext Markup Language (HTML) data, extensible markup language (XML) data, image data, scripts, and other types of data usable, e.g., by a web browser application or other software, to present the map-based GUI. Mapping system 142 may transmit the map-based GUI to client computing system 104. In this example, client computing system 104 may process the map-based GUI data and output the resulting map-based GUI for display by display device 126. In some examples, mapping system 142 may be implemented in a computing device other than a server computing system and mapping system 142 cause a display device of the computing system to display the map-based GUI.

The map-based GUI may include a map that includes indicators of geographic locations of destinations. Mapping system 142 may receive indications of user input to filter the destinations based on one or more criteria. For example, the destinations may include pharmacies and mapping system 142 may filter the pharmacies based on whether the pharmacies are participating in specific pharmacy benefit management networks. In another example, mapping system 142 may filter the destinations based on hours of operation.

FIG. 3 is a flowchart illustrating an example operation for determining Elo ratings of destinations, in accordance with one or more techniques of this disclosure. In the example of FIG. 3, rating system 140 may determine, for each respective user (e.g., each user specified by a combination in the filtered data set), a most-utilized destination for the respective user (300). Among destinations specified by combinations in the filtered data set that specify the respective user, the most-utilized destination for the respective user is a destination most utilized by the respective user. For example, for a given patient, the most-utilized destination may be the pharmacy that the given patient uses most, aside from a closest pharmacy to the given patient.

As discussed above, the filtered data set does not include any combination in the initial data set in which a distance from a geographic location of the destination of the combination to the geographic location of the user of the combination is greater than a distance from a geographic location of the most-utilized destination for the user of the respective combination to the geographic location of the user of the combination. Filtering out such destinations may filter out combinations where users utilize more distant destinations out of occasional convenience than because of actual preference for the destinations. Filtering combinations in this way may prevent such combinations from distorting ratings of the destinations.

Likewise, rating system 140 may determine one or more less-utilized destinations for the respective user (302). The less-utilized destinations for the respective user are destinations specified by the combinations in the filtered data set that are less utilized by the respective user than the destination for the respective user. For example, the less-utilized destination may be pharmacies that a patient occasionally visits that are not the respective user's closest destination, are within a threshold distance, and are not further from the user's geographic location than the respective user's most-utilized destination. In some examples, the filtered users include at least a first user and a second user, the destinations include a first destination and a second destination, the first destination is the most-utilized destination for the first user and the second destination is one of the less-utilized destinations for the first user, and the second destination is the most-utilized destination for the second user and the first destination is one of the less-utilized destinations for the second user.

Furthermore, rating system 140 may perform one or more processing rounds. In each processing round, rating system 140 may generate tournament data for the processing round (304) and update ratings of the destinations based on the tournament data for the processing round (306). As part of generating the tournament data for the processing round, rating system 140 may, for each respective user of the plurality of users, generate matchup data for the respective user. For each respective less-utilized destination of the less-utilized destinations for the respective user, the matchup data for the respective user comprises a respective matchup entry that indicates that the most-utilized destination for the respective user defeats the respective less-utilized destination.

Each combination of the respective user's less-utilized destinations with the respective user's most-utilized destination may be conceptualized as a game. The set of matchups/games between the respective user's less-utilized destinations and the respective user's most-utilized destination may be conceptualized as a tournament. Thus, one tournament may occur in each processing round for each of the users. An individual destination may participate in multiple tournaments during a processing round, either as a user's most-utilized destination or one of the user's less-utilized destinations. Thus, each user may be associated with a tournament. By using pairwise comparisons between the most-utilized destination by that user against each of the remaining destination options, these pairwise comparisons are treated as games within a tournament, whereby the former destination would be the winner of each of these games and the latter destinations being the loser of their respective game.

For example, if the destination X is the respective user's most-utilized destination and destinations Y and Z are the respective user's less utilized destinations, the matchup data may indicate that X defeats Y and X defeats Z. Thus, X versus Y may be a first game and X versus Z may be a second game. A tournament comprises the first game and the second game.

In some examples, the ratings of the destinations are Elo ratings. In such examples, each of the destinations starts a processing round with the same initial Elo rating, R_{estab}. For instance, each of the destinations may start with an Elo rating of 1500. Rating system 140 may update the Elo ratings of the destinations at the end of each processing round. To update the Elo rating of a destination, rating system 140 may perform a series of calculations:

$$K = a + \frac{b - a}{g} \qquad ( 1 )$$

$${E}_{W} = \frac{{10}^{\frac{{R}_{W}}{480}}}{{10}^{\frac{{R}_{W}}{480}} + {10}^{\frac{{R}_{L}}{480}}} \qquad ( 2 )$$

$${E}_{L} = \frac{{10}^{\frac{{R}_{L}}{480}}}{{10}^{\frac{{R}_{W}}{480}} + {10}^{\frac{{R}_{L}}{480}}} \qquad ( 3 )$$

$${R}_{W}^{′} = {R}_{W} + K ( 1 - {E}_{W} ) \qquad ( 4 )$$

$${R}_{L}^{′} = {R}_{L} + K ( 0 - {E}_{L} ) \qquad ( 5 )$$

In the equations above, K indicates a K-factor, which is the maximum possible rating adjustment per game. The value a is a parameter which represents the minimum value the K-factor can take. b is a parameter which represents the maximum value the K-factor can take; and g indicates a number of games within a tournament. An example value of a may be 12.5. An example value of b may be 27.5. The value g may correspond to the number of matchup in the tournament, which is equivalent to the number of destinations (under consideration for that user) minus 1. E_{W} indicates an expected score of the winning destination, prior to the game result; R_{W} indicates the Elo rating of the winning destination in a game, before the ratings are updated to reflect the game result; R_{L} indicates the Elo rating of the losing destination in a game, before the ratings are updated to reflect the game result. E_{L} indicates an expected score of the losing destination, prior to the game result.

$${R}_{W}^{′}$$

indicates the Elo rating of the winning destination in a game, after the ratings are updated to reflect the game result.

$${R}_{L}^{′}$$

indicates the Elo rating of the losing destination in a game, after the ratings are updated to reflect the game result. In each processing round, rating system 140 may reset the Elo rating of each of the destinations to the initial Elo rating and apply equations (1)-(5) for each game in each tournament. Rating system 140 may set the rating of a destination based on an average of the Elo ratings of the destination at the end of each processing round. The order of the tournaments being randomly changed with every processing round.

In this way, during a processing round, for each respective less-utilized destination for each respective user of the filtered users, rating system 140 may mitigate a rating of the respective less-utilized destination for each matchup entry that indicates that the most-utilized destination for the respective user defeats the respective less-utilized destination for the respective user. For each respective user of the filtered users, rating system 140 may enhance a rating of the most-utilized destination for the respective user for each respective matchup entry that indicates that the most-utilized destination for the respective user defeats the respective less-utilized destination for the respective user. Mitigating and enhancing a rating may each apply to increasing or decreasing the rating as needed depending on how the ratings of calculated.

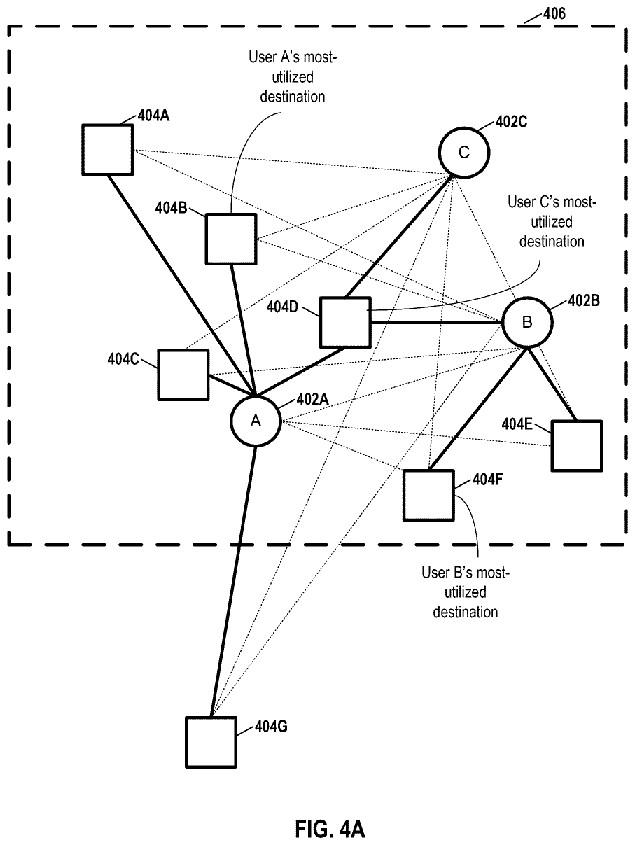

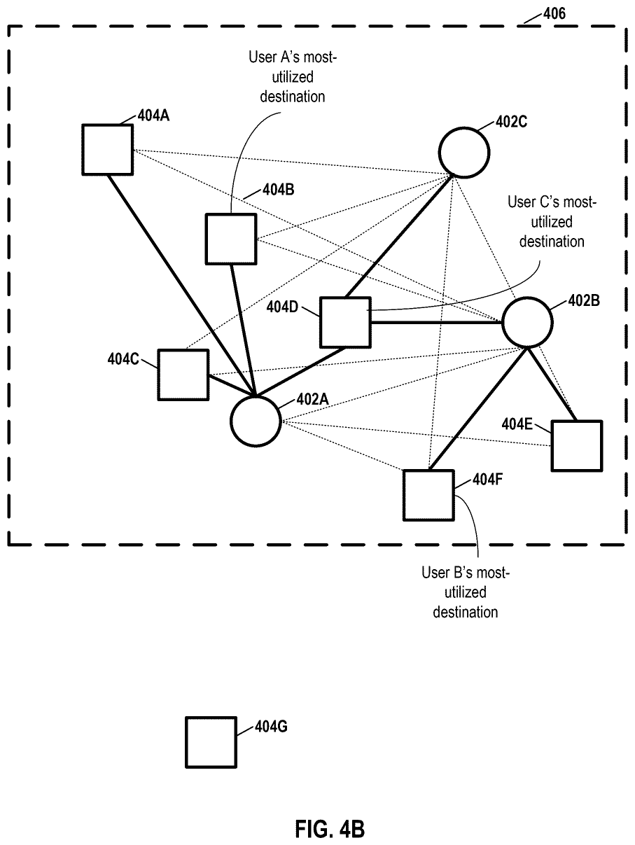

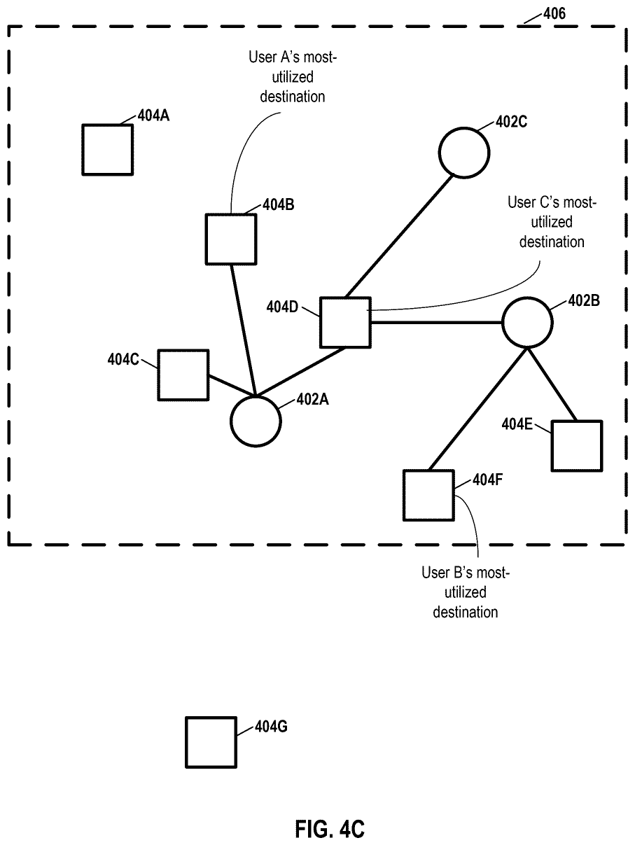

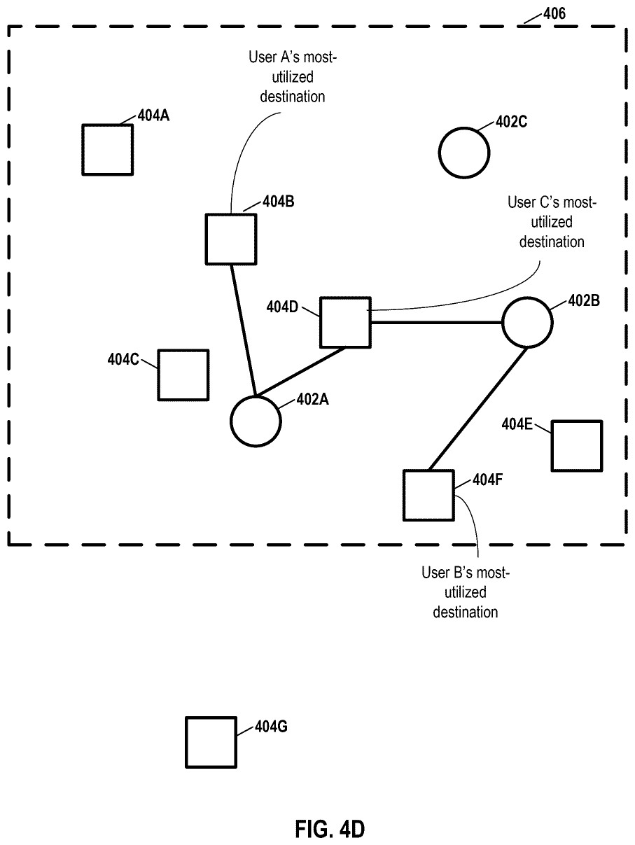

FIGS. 4A-4D are conceptual diagrams illustrating an example process for determining a filtered data set. FIG. 4A is a conceptual diagram illustrating an example set of combinations, in accordance with one or more techniques of this disclosure. In the example of FIG. 4, circles indicate the geographic locations of users 402A, 402B, and 402C. Squares indicate the geographic location locations of destinations 404A-404G (collectively, “destinations 404”). A line connecting a circle to a square indicates a combination. Dotted lines indicate combinations for which the user has not utilized the destination. Solid lines indicate combinations for which the user has utilized the destination. The lengths of the lines as shown in FIG. 4A represent distances between the geographic locations of the users and the geographic locations of the destinations.

Thus, in the example of FIG. 4A, an initial data set may include combinations of each of users 402A with each of destinations 404:
[402A-404A, 402A-404B, 402A-404C, 402A-404D, 402A-404E, 404A-404F, 404A-404G]
[402B-404A, 402B-404B, 402B-404C, 402B-404D, 402B-404E, 404B-404F, 404A-404G]
[402C-404A, 402C-404B, 402C-404C, 402C-404D, 402C-404E, 404C-404F, 404C-404G]

Furthermore, as indicated in the example of FIG. 4A, destination 404B is the most-utilized destination for user 402A. Destination 404F is the most-utilized destination for user 402B. Destination 404D is the most-utilized destination for user 402C.

In accordance with one or more techniques of this disclosure, rating system 140 may determine a filtered data set from the initial data set. As an initial step of determining the filtered data set, rating system 140 may exclude combinations where the distances between the geographic locations of the users and the destinations are greater than one or more distance thresholds (e.g., latitude/longitude differences, radial distances, etc.). In FIGS. 4A-4D, line 406 indicates the one or more distance thresholds. Thus, as shown in FIG. 4B, the combinations 402A-404G, 402B-404G, and 402C-404G are removed, resulting in the following remaining combinations:
[402A-404A, 402A-404B, 402A-404C, 402A-404D, 402A-404E, 404A-404F]
[402B-404A, 402B-404B, 402B-404C, 402B-404D, 402B-404E, 404B-404F]
[402C-404A, 402C-404B, 402C-404C, 402C-404D, 402C-404E, 404C-404F]

Next, rating system 140 may exclude combinations where distances between the geographic locations of the users and destinations is greater than distances between the geographic locations of the user's most-utilized destination. Thus, as shown in FIG. 4C, the combinations 402A-404A, 402A-404E, 402A-404F, 402B-404A, 402B-404B, 402B-404C, 402C-404A, 402C-404B, 402C-404C, 402C-404E, and 402C-404F are removed, resulting in the following remaining combinations:
[402A-404B, 402A-404C, 402A-404D]
[402B-404D, 402B-404E, 404B-404F]
[402C-404D]

Next, rating system 140 may exclude combinations where the destination is the closest destination to the geographic location of the user. Thus, the filtered data set does not include any combination in the initial data set in which a geographic location of a destination of the combination is closer to a geographic location of a user of the combination than a geographic location of any other destination in the plurality of destinations. Thus, as shown in FIG. 4D, the combinations 402A-404C, 404B-404E, and 402C-404D are removed, resulting in the following remaining combinations:
[402A-404B, 402A-404D]
[402B-404D, 404B-404F]

Thus, for user 402A, tournament data for a processing round may include matchup data indicating that destination 404B defeats destination 404D. For user 402B, tournament data for a processing round may include matchup data indicating that destination 404F defeats destination 404D. There is no tournament data for user 402C.

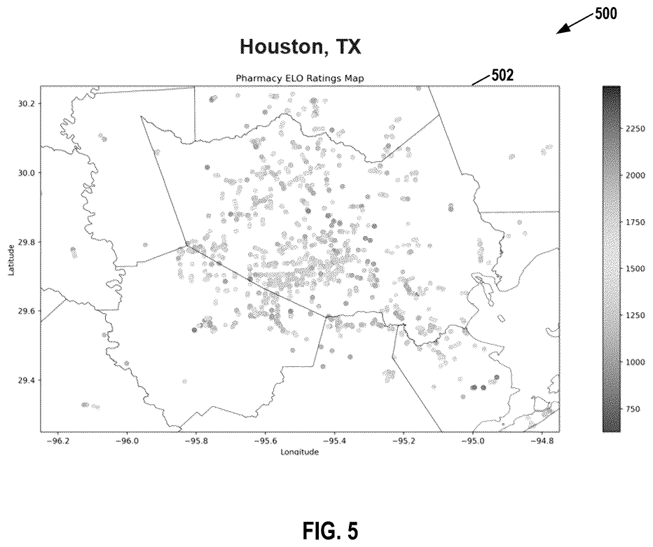

FIG. 5 illustrates an example graphical user interface (GUI) 500 in accordance with one or more techniques of this disclosure. In the example of FIG. 5, GUI 500 includes a map 502 and indicators shown as circles. The indicators indicate geographic locations of individual destinations. In some examples, mapping system 142 may update GUI 500 in response to user inputs to change a scale level of map 502, e.g., to zoom in or zoom out on specific areas. In some examples, mapping system 142 may include features for planning transportation routes to the geographic locations of the destinations. In some examples, GUI 500 is configured to display animations to indicators to show changes in rating/ranking of destinations over time. For instance, GUI 500 may be configured to show an indicator that transitions through a progression of colors to represent how the rating/ranking of a destination has changed over the course of a time period.

The following is a non-limiting list of clauses that are in accordance with one or more techniques of this disclosure.

Clause 1. A computer-implemented method comprising: obtaining, by one or more processors, an initial data set comprising a plurality of combinations of users in a plurality of users and destinations in a plurality of destinations; determining, by the one or more processors, a filtered data set from the initial data set, wherein the filtered data set does not include any combination in the initial data set in which: a distance from a geographic location of a destination of the combination to a geographic location of a user of the combination is greater than a threshold distance, the distance from the geographic location of the destination to the geographic location of the user is greater than a distance from the geographic location of the user to a geographic location of a most-utilized destination for the user among the plurality of destinations, and the geographic location of the destination is closer to the geographic location of the user than a geographic location of any other destination in the plurality of destinations; determining, by the one or more processors, ratings of filtered destinations, the filtered destinations being destinations specified by the combinations in the filtered data set, wherein the ratings of the filtered destinations are based on relative utilization of the filtered destinations by filtered users, the filtered users being users specified by the combinations in the filtered data set; and receiving, by the one or more processors, a map request; and in response to the map request, causing, by the one or more processors, a display device to display a map comprising indicators that indicate geographic locations of a subset of the destinations and information based on the ratings of destinations in the subset of the destinations.

Clause 2. The computer-implemented method of clause 1, wherein determining the ratings of the filtered destinations comprises: for each respective user of the filtered users: determining one or more less-utilized destinations for the respective user, wherein the less-utilized destinations for the respective user are destinations specified by the combinations in the filtered data set that are less utilized by the respective user than the most-utilized destination for the respective user; for each processing round of a set of one or more processing rounds: generating tournament data for the processing round, wherein the tournament data for the processing round includes matchup data for the filtered users, wherein generating the tournament data for the processing round comprises, for each respective user of the filtered users, generating matchup data for the respective user, wherein, for each respective less-utilized destination of the less-utilized destinations for the respective user, the matchup data for the respective user comprises a respective matchup entry that indicates that the most-utilized destination for the respective user defeats the respective less-utilized destination; and updating the ratings of the destinations based on the tournament data for the processing round.

Clause 3. The computer-implemented method of clause 2, wherein updating the ratings of the destinations comprises: for each respective less-utilized destination for each respective user of the filtered users, mitigating a rating of the respective less-utilized destination for each matchup entry that indicates that the most-utilized destination for the respective user defeats the respective less-utilized destination for the respective user; and for each respective user of the filtered users, enhancing a rating of the most-utilized destination for the respective user for each respective matchup entry that indicates that the most-utilized destination for the respective user defeats the respective less-utilized destination for the respective user.

Clause 4. The computer-implemented method of any of clauses 2-3, the filtered users include at least a first user and a second user, the destinations include a first destination and a second destination, the first destination is the most-utilized destination for the first user and the second destination is one of the less-utilized destinations for the first user, and the second destination is the most-utilized destination for the second user and the first destination is one of the less-utilized destinations for the second user.

Clause 5. The computer-implemented method of any of clauses 1-4, wherein the method further comprises: identifying, by the one or more processors, the subset of the destinations based on one or more criteria; generating, by the one or more processors, a ranking of destinations in the subset of the destinations based on the ratings of the destinations, wherein the indicators provide information regarding the ranking of the destinations in the subset of the destinations.

Clause 6. The computer-implemented method of clause 5, wherein: receiving the map request comprises receiving the map request from a client computing system for GUI data, the display device is associated with the client computing system, causing the display device to display the map comprises sending, by the one or more processors, the GUI data to the client computing system in response to the map request.

Clause 7. The computer-implemented method of clause 6, wherein the method further comprises: determining, by the one or more processors, based on data sent by the client computing system, a geographic location associated with a user of the client computing system; and determining, by the one or more processors, the subset of the destinations based on the geographic location associated with the user.

Clause 8. The computer-implemented method of any of clauses 1-7, further comprising: obtaining, by the one or more processors, usage data from the destinations; and generating, by the one or more processors, the initial data set based on the usage data.

Clause 9. The computer-implemented method of any of clauses 1-8, wherein the ratings are Elo ratings.

Clause 10. A system comprising: one or more processors: and one or more memories storing processor-executable instructions that, when executed by the one or more processors, cause the one or more processors to perform operations comprising: obtaining an initial data set comprising a plurality of combinations of users in a plurality of users and destinations in a plurality of destinations; determining a filtered data set from the initial data set, wherein the filtered data set does not include any combination in the initial data set in which: a distance from a geographic location of a destination of the combination to a geographic location of a user of the combination is greater than a threshold distance, the distance from the geographic location of the destination to the geographic location of the user is greater than a distance from the geographic location of the user to a geographic location of a most-utilized destination for the user among the plurality of destinations, and the geographic location of the destination is closer to the geographic location of the user than a geographic location of any other destination in the plurality of destinations; determining ratings of filtered destinations, the filtered destinations being destinations specified by the combinations in the filtered data set, wherein the ratings of the filtered destinations are based on relative utilization of the filtered destinations by filtered users, the filtered users specified by the combinations in the filtered data set; receiving a map request; and in response to the map request, causing a display device to display a map comprising indicators that indicate geographic locations of a subset of the destinations and information based on the ratings of destinations in the subset of the destinations.

Clause 11. The system of clause 10, wherein determining the ratings of the filtered destinations comprises: for each respective user of the filtered users: determining one or more less-utilized destinations for the respective user, wherein the less-utilized destinations for the respective user are destinations specified by the combinations in the filtered data set that are less utilized by the respective user than the most-utilized destination for the respective user; for each processing round of a set of one or more processing rounds: generating tournament data for the processing round, wherein the tournament data for the processing round includes matchup data for the filtered users, wherein generating the tournament data for the processing round comprises, for each respective user of the filtered users, generating matchup data for the respective user, wherein, for each respective less-utilized destination of the less-utilized destinations for the respective user, the matchup data for the respective user comprises a respective matchup entry that indicates that the most-utilized destination for the respective user defeats the respective less-utilized destination; and updating the ratings of the destinations based on the tournament data for the processing round.

Clause 12. The system of clause 11, wherein updating the ratings of the destinations comprises: for each respective less-utilized destination for each respective user of the filtered users, mitigating a rating of the respective less-utilized destination for each matchup entry that indicates that the most-utilized destination for the respective user defeats the respective less-utilized destination for the respective user; and for each respective user of the filtered users, enhancing a rating of the most-utilized destination for the respective user for each respective matchup entry that indicates that the most-utilized destination for the respective user defeats the respective less-utilized destination for the respective user.

Clause 13. The system of any of clauses 11-12, the filtered users include at least a first user and a second user, the destinations include a first destination and a second destination, the first destination is the most-utilized destination for the first user and the second destination is one of the less-utilized destinations for the first user, and the second destination is the most-utilized destination for the second user and the first destination is one of the less-utilized destinations for the second user.

Clause 14. The system of any of clauses 10-13, wherein the operations further comprise: identifying the subset of the destinations based on one or more criteria; generating a ranking of destinations in the subset of the destinations based on the ratings of the destinations, wherein the indicators provide information regarding the ranking of the destinations in the subset of the destinations.

Clause 15. The system of any of clauses 10-14, wherein the operations further comprise: identifying the subset of the destinations based on one or more criteria; generating a ranking of destinations in the subset of the destinations based on the ratings of the destinations, wherein the indicators provide information regarding the ranking of the destinations in the subset of the destinations.

Clause 16. The system of clause 15, wherein: receiving the map request comprises receiving the map request from a client computing system for GUI data, the display device is associated with the client computing system, causing the display device to display the map comprises sending the GUI data to the client computing system in response to the map request.

Clause 17. The system of clause 16, wherein the operations further comprise: determining, based on data sent by the client computing system, a geographic location associated with a user of the client computing system; and determining the subset of the destinations based on the geographic location associated with the user.

Clause 18. The system of any of clauses 10-17, wherein the operations further comprise: obtaining usage data from the destinations; and generating the initial data set based on the usage data.

Clause 19. One or more non-transitory computer-readable media storing processor-executable instructions that, when executed by one or more processors, cause the one or more processors to perform operations comprising: obtaining an initial data set comprising a plurality of combinations of users in a plurality of users and destinations in a plurality of destinations; determining a filtered data set from the initial data set, wherein the filtered data set does not include any combination in the initial data set in which: a distance from a geographic location of a destination of the combination to a geographic location of a user of the combination is greater than a threshold distance, the distance from the geographic location of the destination to the geographic location of the user is greater than a distance from the geographic location of the user to a geographic location of a most-utilized destination for the user among the plurality of destinations, and the geographic location of the destination is closer to the geographic location of the user than a geographic location of any other destination in the plurality of destinations; determining ratings of filtered destinations, the filtered destinations being destinations specified by the combinations in the filtered data set, wherein the ratings of the filtered destinations are based on relative utilization of the filtered destinations by filtered users, the filtered users being specified by the combinations in the filtered data set; receiving a map request for a mapping application; and in response to the map request, causing a display device to display a map comprising indicators that indicate geographic locations of a subset of the destinations and information based on the ratings of destinations in the subset of the destinations.

Clause 20. The one or more non-transitory computer-readable storage media of clause 19, wherein determining the ratings of the filtered destinations comprises: for each respective user of the filtered users: determining one or more less-utilized destinations for the respective user, wherein the less-utilized destinations for the respective user are destinations specified by the combinations in the filtered data set that are less utilized by the respective user than the most-utilized destination for the respective user; for each processing round of a set of one or more processing rounds: generating tournament data for the processing round, wherein the tournament data for the processing round includes matchup data for the filtered users, wherein generating the tournament data for the processing round comprises, for each respective user of the filtered users, generating matchup data for the respective user, wherein, for each respective less-utilized destination of the less-utilized destinations for the respective user, the matchup data for the respective user comprises a respective matchup entry that indicates that the most-utilized destination for the respective user defeats the respective less-utilized destination; and updating the ratings of the destinations based on the tournament data for the processing round.

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A computer-implemented method comprising:
obtaining, by one or more processors, an initial data set comprising a plurality of combinations of users in a plurality of users and destinations in a plurality of destinations;
determining, by the one or more processors, a filtered data set from the initial data set, wherein the filtered data set does not include any combination in the initial data set in which:
a distance from a geographic location of a destination of the combination to a geographic location of a user of the combination is greater than a threshold distance,
the distance from the geographic location of the destination to the geographic location of the user is greater than a distance from the geographic location of the user to a geographic location of a most-utilized destination for the user among the plurality of destinations, and
the geographic location of the destination is closer to the geographic location of the user than a geographic location of any other destination in the plurality of destinations;
determining, by the one or more processors, ratings of filtered destinations, the filtered destinations being destinations specified by the combinations in the filtered data set, wherein the ratings of the filtered destinations are based on relative utilization of the filtered destinations by filtered users, the filtered users being users specified by the combinations in the filtered data set; and
receiving, by the one or more processors, a map request; and
in response to the map request, causing, by the one or more processors, a display device to display a map comprising indicators that indicate geographic locations of a subset of the destinations and information based on the ratings of destinations in the subset of the destinations.

2. The computer-implemented method of claim 1, wherein determining the ratings of the filtered destinations comprises:
for each respective user of the filtered users:
determining one or more less-utilized destinations for the respective user, wherein the less-utilized destinations for the respective user are destinations specified by the combinations in the filtered data set that are less utilized by the respective user than the most-utilized destination for the respective user;
for each processing round of a set of one or more processing rounds:
generating tournament data for the processing round, wherein the tournament data for the processing round includes matchup data for the filtered users,
wherein generating the tournament data for the processing round comprises, for each respective user of the filtered users, generating matchup data for the respective user, wherein, for each respective less-utilized destination of the less-utilized destinations for the respective user, the matchup data for the respective user comprises a respective matchup entry that indicates that the most-utilized destination for the respective user defeats the respective less-utilized destination; and
updating the ratings of the destinations based on the tournament data for the processing round.

3. The computer-implemented method of claim 2, wherein updating the ratings of the destinations comprises:
for each respective less-utilized destination for each respective user of the filtered users, mitigating a rating of the respective less-utilized destination for each matchup entry that indicates that the most-utilized destination for the respective user defeats the respective less-utilized destination for the respective user; and
for each respective user of the filtered users, enhancing a rating of the most-utilized destination for the respective user for each respective matchup entry that indicates that the most-utilized destination for the respective user defeats the respective less-utilized destination for the respective user.

4. The computer-implemented method of claim 2, the filtered users include at least a first user and a second user, the destinations include a first destination and a second destination, the first destination is the most-utilized destination for the first user and the second destination is one of the less-utilized destinations for the first user, and the second destination is the most-utilized destination for the second user and the first destination is one of the less-utilized destinations for the second user.

5. The computer-implemented method of claim 1, wherein the method further comprises:
identifying, by the one or more processors, the subset of the destinations based on one or more criteria;
generating, by the one or more processors, a ranking of destinations in the subset of the destinations based on the ratings of the destinations,
wherein the indicators provide information regarding the ranking of the destinations in the subset of the destinations.

6. The computer-implemented method of claim 5, wherein:
receiving the map request comprises receiving the map request from a client computing system for GUI data,
the display device is associated with the client computing system,
causing the display device to display the map comprises sending, by the one or more processors, the GUI data to the client computing system in response to the map request.

7. The computer-implemented method of claim 6, wherein the method further comprises:
determining, by the one or more processors, based on data sent by the client computing system, a geographic location associated with a user of the client computing system; and
determining, by the one or more processors, the subset of the destinations based on the geographic location associated with the user.

8. The computer-implemented method of claim 1, further comprising:
obtaining, by the one or more processors, usage data from the destinations; and
generating, by the one or more processors, the initial data set based on the usage data.

9. The computer-implemented method of claim 1, wherein the ratings are Elo ratings.

10. A system comprising:
one or more processors; and
one or more memories storing processor-executable instructions that, when executed by the one or more processors, cause the one or more processors to perform operations comprising:
obtaining an initial data set comprising a plurality of combinations of users in a plurality of users and destinations in a plurality of destinations;
determining a filtered data set from the initial data set, wherein the filtered data set does not include any combination in the initial data set in which:
a distance from a geographic location of a destination of the combination to a geographic location of a user of the combination is greater than a threshold distance,
the distance from the geographic location of the destination to the geographic location of the user is greater than a distance from the geographic location of the user to a geographic location of a most-utilized destination for the user among the plurality of destinations, and
the geographic location of the destination is closer to the geographic location of the user than a geographic location of any other destination in the plurality of destinations;
determining ratings of filtered destinations, the filtered destinations being destinations specified by the combinations in the filtered data set, wherein the ratings of the filtered destinations are based on relative utilization of the filtered destinations by filtered users, the filtered users specified by the combinations in the filtered data set;
receiving a map request; and
in response to the map request, causing a display device to display a map comprising indicators that indicate geographic locations of a subset of the destinations and information based on the ratings of destinations in the subset of the destinations.

11. The system of claim 10, wherein determining the ratings of the filtered destinations comprises:
for each respective user of the filtered users:
determining one or more less-utilized destinations for the respective user, wherein the less-utilized destinations for the respective user are destinations specified by the combinations in the filtered data set that are less utilized by the respective user than the most-utilized destination for the respective user;
for each processing round of a set of one or more processing rounds:
generating tournament data for the processing round, wherein the tournament data for the processing round includes matchup data for the filtered users,
wherein generating the tournament data for the processing round comprises, for each respective user of the filtered users, generating matchup data for the respective user, wherein, for each respective less-utilized destination of the less-utilized destinations for the respective user, the matchup data for the respective user comprises a respective matchup entry that indicates that the most-utilized destination for the respective user defeats the respective less-utilized destination; and
updating the ratings of the destinations based on the tournament data for the processing round.

12. The system of claim 11, wherein updating the ratings of the destinations comprises:
for each respective less-utilized destination for each respective user of the filtered users, mitigating a rating of the respective less-utilized destination for each matchup entry that indicates that the most-utilized destination for the respective user defeats the respective less-utilized destination for the respective user; and
for each respective user of the filtered users, enhancing a rating of the most-utilized destination for the respective user for each respective matchup entry that indicates that the most-utilized destination for the respective user defeats the respective less-utilized destination for the respective user.

13. The system of claim 11, the filtered users include at least a first user and a second user, the destinations include a first destination and a second destination, the first destination is the most-utilized destination for the first user and the second destination is one of the less-utilized destinations for the first user, and the second destination is the most-utilized destination for the second user and the first destination is one of the less-utilized destinations for the second user.

14. The system of claim 10, wherein the operations further comprise:
identifying the subset of the destinations based on one or more criteria;
generating a ranking of destinations in the subset of the destinations based on the ratings of the destinations,
wherein the indicators provide information regarding the ranking of the destinations in the subset of the destinations.

15. The system of claim 10, wherein the operations further comprise:
identifying the subset of the destinations based on one or more criteria;
generating a ranking of destinations in the subset of the destinations based on the ratings of the destinations,
wherein the indicators provide information regarding the ranking of the destinations in the subset of the destinations.

16. The system of claim 15, wherein:
receiving the map request comprises receiving the map request from a client computing system for GUI data,
the display device is associated with the client computing system,
causing the display device to display the map comprises sending the GUI data to the client computing system in response to the map request.

17. The system of claim 16, wherein the operations further comprise:
determining, based on data sent by the client computing system, a geographic location associated with a user of the client computing system; and
determining the subset of the destinations based on the geographic location associated with the user.

18. The system of claim 10, wherein the operations further comprise:
obtaining usage data from the destinations; and
generating the initial data set based on the usage data.

19. One or more non-transitory computer-readable media storing processor-executable instructions that, when executed by one or more processors, cause the one or more processors to perform operations comprising:
obtaining an initial data set comprising a plurality of combinations of users in a plurality of users and destinations in a plurality of destinations;
determining a filtered data set from the initial data set, wherein the filtered data set does not include any combination in the initial data set in which:
a distance from a geographic location of a destination of the combination to a geographic location of a user of the combination is greater than a threshold distance,
the distance from the geographic location of the destination to the geographic location of the user is greater than a distance from the geographic location of the user to a geographic location of a most-utilized destination for the user among the plurality of destinations, and
the geographic location of the destination is closer to the geographic location of the user than a geographic location of any other destination in the plurality of destinations;
determining ratings of filtered destinations, the filtered destinations being destinations specified by the combinations in the filtered data set, wherein the ratings of the filtered destinations are based on relative utilization of the filtered destinations by filtered users, the filtered users being specified by the combinations in the filtered data set;
receiving a map request for a mapping application; and
in response to the map request, causing a display device to display a map comprising indicators that indicate geographic locations of a subset of the destinations and information based on the ratings of destinations in the subset of the destinations.

20. The one or more non-transitory computer-readable storage media of claim 19, wherein determining the ratings of the filtered destinations comprises:
for each respective user of the filtered users:
determining one or more less-utilized destinations for the respective user, wherein the less-utilized destinations for the respective user are destinations specified by the combinations in the filtered data set that are less utilized by the respective user than the most-utilized destination for the respective user;
for each processing round of a set of one or more processing rounds:
generating tournament data for the processing round, wherein the tournament data for the processing round includes matchup data for the filtered users,
wherein generating the tournament data for the processing round comprises, for each respective user of the filtered users, generating matchup data for the respective user, wherein, for each respective less-utilized destination of the less-utilized destinations for the respective user, the matchup data for the respective user comprises a respective matchup entry that indicates that the most-utilized destination for the respective user defeats the respective less-utilized destination; and
updating the ratings of the destinations based on the tournament data for the processing round.
